(19) United States
(12) Patent Application Publication
(10) Pub. No.: US 2023/0142925 A1
(43) Pub. Date: May 11, 2023

(54) LEARNING DEVICE, LEARNING METHOD, RECORDING MEDIUM FOR LEARNING DEVICE, INFERENCE DEVICE, INFERENCE METHOD, AND RECORDING MEDIUM FOR INFERENCE DEVICE

(71) Applicant: NEC Corporation, Minato-ku, Tokyo (JP)

(72) Inventor: Shuhei Yoshida, Tokyo (JP)

(73) Assignee: NEC Corporation, Minato-ku, Tokyo (JP)

(21) Appl. No.: 17/918,409

(22) PCT Filed: Apr. 27, 2020
(86) PCT No.: PCT/JP2020/017963

§ 371 Date: Oct. 12, 2022

(51) Int. Cl. G06N 20/00; G06N 5/04

(52) U.S. Cl. CPC G06N 20/00; G06N 5/04

(57) ABSTRACT

A recognition loss calculation unit of a learning device calculates a recognition loss using a recognition result with respect to recognition object data in a dataset for learning that is a set of pairs of the recognition object data and a weak label, a mixing matrix calculated based on the dataset for learning, and a weak label attached to the recognition object data. The recognition loss calculation unit includes a conversion unit that converts the recognition result into a conjugate vector, a mixing matrix product calculation unit that calculates a product of the conjugate vector and the mixing matrix, a normalization term calculation unit that calculates a normalization term from the conjugate vector, and a total sum calculation unit.

### TECHNICAL FIELD

The present invention relates to a learning device, a learning method, a recording medium for a learning device, an inference device, an inference method, and a recording medium for an inference device.

### BACKGROUND ART

In recent years, recognition techniques using machine learning have come to show extremely high performance mainly in the field of image recognition. The high accuracy of recognition techniques based on machine learning is supported by a large amount of learning data with correct answers. However, the cost of data collection and correctly answering is high, and in particular, the cost of correctly answering multi-class classification increases as the number of classes increases.

Non-Patent Literature 1 proposes a method of using, in multi-class classification, a dataset with a weak label determined probabilistically from a true correct answer label instead of attaching a true correct answer label indicating a class to which all recognition objects belong. However, Non-Patent Literature 1 uses, for learning, a loss function calculated by adding a positive semi-definite value function with a mixing matrix containing a negative component as a weight, and causes overfitting for data that has a negative contribution to the loss function.

### CITATION LIST

### Patent Literature

[Non Patent Literature 1]
Cid-Sueiro, J., Garcia-Garcia, D., and Santos-Rodoriguez, R., “Consistency of losses for learning from weak labels,” In ECML-PKDD, 2014

### SUMMARY OF THE INVENTION

### Problem to be Solved by the Invention

An object of this disclosure is to provide a learning device, a learning method, a recording medium for a learning device, an inference device, an inference method, and a recording medium for an inference device that make it possible to improve the above-mentioned techniques.

### Means for Solving the Problem

According to an example embodiment of the present disclosure, a learning device is provided including: a recognition means that outputs a recognition result with respect to recognition object data in a dataset for learning that is a set of pairs of the recognition object data and a weak label attached to the recognition object data; and a recognition loss calculation means that calculates a recognition loss using the recognition result, a mixing matrix calculated based on the dataset for learning, and the weak label, wherein the dataset for learning has a weak label probability distribution, the weak label probability distribution is a probability distribution according to the weak label conditioned by a true correct answer class to which the recognition object data belongs, and is reconfigurable, the recognition loss calculation means includes a conversion means that converts the recognition result into a conjugate vector, a mixing matrix product calculation means that calculates a product of the conjugate vector and the mixing matrix, a normalization term calculation means that calculates a normalization term from the conjugate vector, and a total sum calculation means that calculates a sum of the product and the normalization term and outputs the calculated sum as the recognition loss, and the recognition means performs learning using the recognition loss.

According to an example embodiment of the present disclosure, a learning method is provided including: a recognition step of outputting a recognition result with respect to recognition object data in a dataset for learning that is a set of pairs of the recognition object data and a weak label attached to the recognition object data; and a recognition loss calculation step of calculating a recognition loss using the recognition result, a mixing matrix calculated based on the dataset for learning, and the weak label, wherein the dataset for learning has a weak label probability distribution, the weak label probability distribution is a probability distribution according to the weak label conditioned by a true correct answer class to which the recognition object data belongs, and is reconfigurable, the recognition loss calculation step includes a conversion step of converting the recognition result into a conjugate vector, a mixing matrix product calculation step of calculating a product of the conjugate vector and the mixing matrix, a normalization term calculation step of calculating a normalization term from the conjugate vector, and a total sum calculation step of calculating a sum of the product and the normalization term and outputting the calculated sum as the recognition loss, and the recognition step further includes a step of performing learning using the recognition loss.

According to an example embodiment of the present disclosure, a recording medium is provided for a learning device in which a program for causing a computer to execute a learning method is recorded, the learning method including: a recognition step of outputting a recognition result with respect to recognition object data in a dataset for learning that is a set of pairs of the recognition object data and a weak label attached to the recognition object data; and a recognition loss calculation step of calculating a recognition loss using the recognition result, a mixing matrix calculated based on the dataset for learning, and the weak label, wherein the dataset for learning has a weak label probability distribution, the weak label probability distribution is a probability distribution according to the weak label conditioned by a true correct answer class to which the recognition object data belongs, and is reconfigurable, the recognition loss calculation step includes a conversion step of converting the recognition result into a conjugate vector, a mixing matrix product calculation step of calculating a product of the conjugate vector and the mixing matrix, a normalization term calculation step of calculating a normalization term from the conjugate vector, and a total sum calculation step of calculating a sum of the product and the normalization term and outputting the calculated sum as the recognition loss, and the recognition step further includes a step of performing learning using the recognition loss.

According to an example embodiment of the present disclosure, an inference device is provided including: a recognition means trained by the above learning device; a conversion means that converts an output of the recognition means into a conjugate vector; and a class posterior probability calculation means that converts the conjugate vector into a class posterior probability.

According to an example embodiment of the present disclosure, an inference method is provided including: a recognition step of outputting a recognition result of input data using a recognition means trained by the above learning device; a conversion step of converting the recognition result into a conjugate vector; and a class posterior probability calculation step of converting the conjugate vector into a class posterior probability.

According to an example embodiment of the present disclosure, a recording medium is provided for an inference device in which a program for a computer to execute an inference method is recorded, the inference method including: a recognition step of outputting a recognition result of input data using a recognition means trained by the above learning device; a conversion step of converting the recognition result into a conjugate vector, a class posterior probability calculation step of converting the conjugate vector into a class posterior probability.

### BRIEF DESCRIPTION OF THE DRAWINGS

FIG. 1A shows an example of a normal dataset in the case of a multi-class classification problem.

FIG. 1B shows an example (an expert dataset) of a weak label dataset in the case of a multi-class classification problem.

FIG. 2 is a block diagram illustrating an example of a hardware configuration of a learning device.

FIG. 3 is a block diagram illustrating a functional configuration of the learning device.

FIG. 4 is a block diagram illustrating a detailed functional configuration of a recognition loss calculation unit.

FIG. 5 is a flowchart illustrating an operation of the learning device.

FIG. 6 is a flowchart illustrating an operation of the recognition loss calculation unit.

FIG. 7 is a block diagram illustrating an example of a hardware configuration of an inference device.

FIG. 8 is a block diagram illustrating a functional configuration of the inference device.

FIG. 9 is a flowchart illustrating an operation of the inference device.

FIG. 10 is a diagram illustrating a minimum configuration diagram of the learning device.

FIG. 11 is a flowchart illustrating an operation in the minimum configuration of the learning device.

### EXAMPLE EMBODIMENTS

Hereinafter, a preferred example embodiment of the present invention will be described with reference to the accompanying drawings.

### [Weak Label Dataset]

First, a dataset to which a weak label is attached (hereinafter referred to as a “weak label dataset”) used in an example embodiment of the present invention will be described.

In the present example embodiment, a multi-class classification in which an element x of a data space X is classified into a correct answer class y that is an element of a correct answer candidate set Y is considered.

A normal dataset for learning in a multi-class classification problem is a set D of pairs (x, y) of the data x that is an element of the data space X and the correct answer class y that is an element of the correct answer candidate set Y.

[Math. 1]

D={(xᵢ,yᵢ)}ᵢ₌₁^{N} (1)

The set D is shown as above.

The weak label dataset is a set D_{w} of pairs (x, z) of the data x that is an element of the data space X and a weak label z that is an element of a weak label set Z, and

[Math. 2]

D_{w}={(xᵢ,zᵢ)}ᵢ₌₁^{N} (2)

has the following weak label probability distribution.

[Math. 3]

p(z|y) (3)

The weak label probability distribution is limited to one having a mixing matrix H satisfying the following expression, that is, one that is reconfigurable.

[Math. 4]

Σ_{z∈Z}H_{yz}p(z|y′)=1[y=y′] (4)

Here, 1[y=y′] takes a value of 1 when y and y′ are equal to each other and a value of 0 when they are different from each other. The weak label z attached to the data x that is an element of the data space Xis an element of the weak label set Z and is determined in accordance with the weak label probability distribution from the true correct answer class y to which the data x belongs. That is, when the true class to which the data xᵢ belongs is yᵢ, the probability of the weak label zᵢ being attached to the data xᵢ is given by the following expression using the weak label probability distribution of Expression (3).

[Math. 5]

p(zᵢ|yᵢ) (5)

The actually attached weak label zᵢ is a realization value of the weak label zᵢ sampled in accordance with Expression (5).

Next, an expert dataset and a PU dataset will be described as specific examples of the weak label dataset. For these specific examples, there is a mixing matrix satisfying Expression (4). However, the weak label dataset used in the example embodiment of the present invention is not limited to the expert dataset and the PU dataset.

[1] Expert Dataset

The “expert dataset” is a dataset for learning that can be used when learning a model of multi-class classification, and is constituted by a plurality of partial datasets. Specifically, the expert dataset is configured to satisfy the following conditions.

(A) At least a portion of the class included in the correct answer candidate set Y is allocated to each of the plurality of partial datasets as the area of responsibility.

(B) All the classes included in the correct answer candidate set Y are allocated to any of the plurality of partial datasets.

(C) Any of the classes belonging to the area of responsibility allocated to the partial dataset or a weak label indicating that the recognition object class does not belong to the area of responsibility of the partial dataset is attached to each piece of data included in the partial dataset.

From the condition (C), the weak label set Z in the expert dataset includes each class included in the correct answer candidate set Y and a label indicating that it is out of the area of responsibility of each partial dataset. When the data x that is an element of the data space X belongs to the true class y that is an element of the correct answer candidate set Y, the weak label attached to the data x is determined according to which partial dataset this data x is included in. In a case where the area of responsibility of the partial dataset including the data x includes the true class y, the weak label z attached to the data x indicates the true class y. On the other hand, in a case where the area of responsibility of the partial dataset including the data x does not include the true class y, the weak label z indicating that “the true class is out of the area of responsibility of the partial dataset” is attached to the data x. In this way, even in the case of the data x belonging to the same class y, the weak label z to be attached is determined by a probabilistic element of which partial dataset it is included in. In addition, the condition (B) ensures that there is a mixing matrix H with respect to the probability distribution for determining the weak label. From the above, the expert dataset satisfies the requirements of “a dataset to which the weak label is attached” used in the present invention.

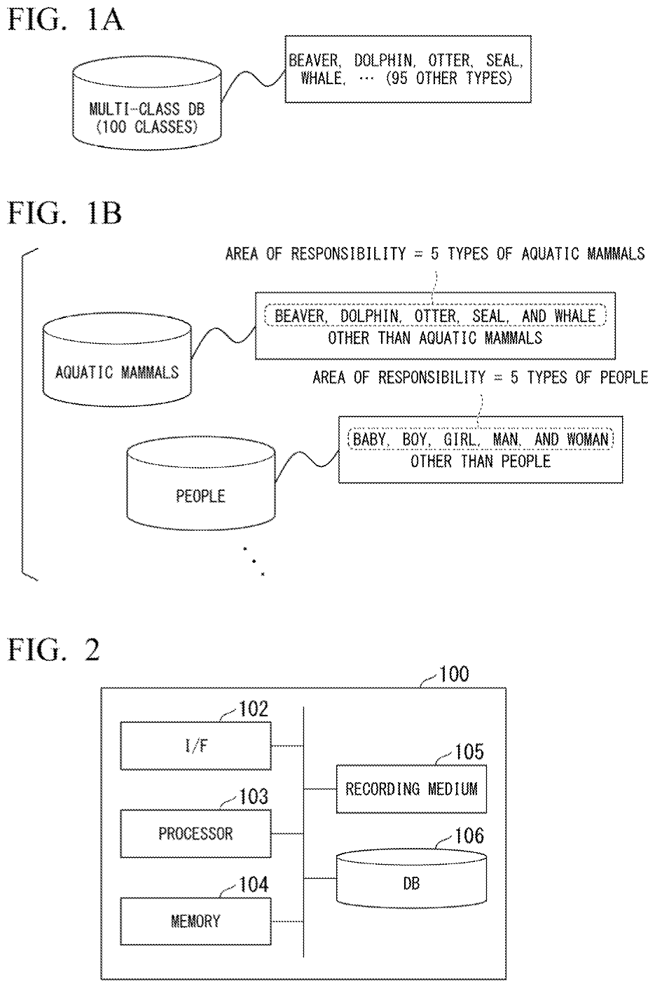

FIG. 1B shows an example of an expert dataset. It is assumed here that an object recognition model that performs multi-class classification of one hundred classes on the basis of image data is learned. In the expert dataset, a plurality of partial datasets are prepared. In the example of FIG. 1B, a plurality of partial datasets such as “aquatic mammals” and “people” are prepared. The area of responsibility is set for each partial dataset. Five types of aquatic mammals, “beaver,” “dolphin,” “otter,” “seal,” and “whale,” are allocated to the partial dataset of “aquatic mammals” as the area of responsibility. Five types of people, “baby,” “boy,” “girl,” “man,” and “woman,” are allocated to the partial dataset of “people” as the area of responsibility. Here, the area of responsibility is determined so that all the classes included in the correct answer candidate set Y are included in the area of responsibility of at least one partial dataset. That is, one hundred classes are allocated to a plurality of partial datasets so that no class is not allocated to any of the partial datasets. In other words, the area of responsibility is determined so that one hundred classes of recognition objects are all covered by a plurality of partial datasets. This also makes it possible to learn one hundred classes of multi-class classification with the expert dataset.

In the expert dataset, for each piece of image data included in each partial dataset, a correct answer label indicating any of the categories belonging to the area of responsibility or a label indicating that the category of the image data does not belong to the area of responsibility of the partial dataset is prepared. In the example of FIG. 1B, for the image data included in the partial dataset of “aquatic mammals,” a correct answer label indicating any of “beaver,” “dolphin,” “otter,” “seal,” and “whale” or a label of “not an aquatic mammal” indicating that the category of the image data does not belong to the area of responsibility of the partial dataset is prepared. For example, in a case where an image of “baby” is included in the partial dataset of “aquatic mammals,” a label of “not an aquatic mammal” is attached to this image.

Using such an expert dataset makes it possible to drastically reduce the workload of correctly answering the learning data. In the case of the normal dataset shown in FIG. 1A, it is necessary to attach any of one hundred categories to all the prepared pieces of image data as a correct answer label. For example, in a case where sixty thousand pieces of image data are prepared as learning data, it is necessary to allocate any of one hundred categories to all of them as a correct answer label. On the other hand, in the case of the expert dataset shown in FIG. 1B, sixty thousand pieces of image data are divided into, for example, twenty sets, and twenty partial datasets are prepared. In addition, one hundred categories that are recognition objects are divided into twenty sets, and five categories are allocated to each partial dataset as the area of responsibility. Then, as shown in FIG. 1B, the correct answer label of any of five categories belonging to the partial dataset or any of a total of six correct answer labels indicating that they do not belong to the area of responsibility of the partial dataset may be attached to the image data belonging to each partial dataset. That is, any of the six correct answer labels may be attached to each partial dataset.

[2] PU Dataset

A PU dataset will be described as an example of a dataset to which another weak label is attached.

The PU dataset is a dataset of a two-class classification problem for classifying the data x that is an element of the data space X into a positive class (denoted as P) and a negative class (denoted as N). In the dataset of the two-class classification problem, a label indicating whether the data x belongs to P or N is attached to the data. That is, a true correct answer label is attached to all pieces of data included in the dataset. On the other hand, a label indicating that the data x belongs to P or a label (denoted as U) indicating that the true correct answer is unknown is attached to the data x of the PU dataset. That is, the PU dataset has the weak label set Z, wherein Z includes a label indicating that it belongs to P and a label indicating that the true correct answer is unknown.

In a case where the data x that is an element of the data space X belongs to the true correct answer class P, it is probabilistically determined which of P and U that are elements of the weak label set Z is attached to the data x. On the other hand, in a case where the data x belongs to the true correct answer class N, the weak label attached to the data x is U with a probability 1.

In a case where advanced expertise or cost are required to identify the true correct answer class, using the PU dataset makes it possible to drastically reduce the workload of correctly answering the learning data. This will be described with an example of medical image identification for identifying whether an input image contains a lesion (positive class⋅P) or is normal (negative class⋅N). It requires advanced expertise of a doctor to look at the image and determine whether it contains a lesion. Therefore, in order to create a normal dataset for learning a two-class classification problem, it is necessary for a doctor to confirm all the images and attach a correct answer label. On the other hand, in order to create the PU dataset, it is not necessary to make a diagnosis for all the images, and when a certain number of images containing lesions (that is, P) are collected, a weak label U can be attached to all the remaining images to complete the creation of learning data.

[Example Embodiment of Learning Device]

Next, an example embodiment of a learning device using a weak label dataset will be described.

(Hardware Configuration)

FIG. 2 is a block diagram illustrating a hardware configuration of a learning device according to an example embodiment. As shown in the drawing, a learning device 100 includes an interface 102, a processor 103, a memory 104, a recording medium 105, and a database (DB) 106.

The interface 102 inputs and outputs data to and from an external device. Specifically, a weak label dataset used for learning of the learning device 100 is input through the interface 102.

The processor 103 is a central processing unit (CPU) or a computer such as a CPU and a graphics processing unit (GPU) and controls the entirety of the learning device 100 by executing a program prepared in advance. Specifically, the processor 103 executes a learning process to be described later.

The memory 104 is constituted by a read only memory (ROM), a random-access memory (RAM), or the like. The memory 104 stores a model which is learned by the learning device 100. In addition, the memory 104 is also used as a working memory during the execution of various processes performed by the processor 103.

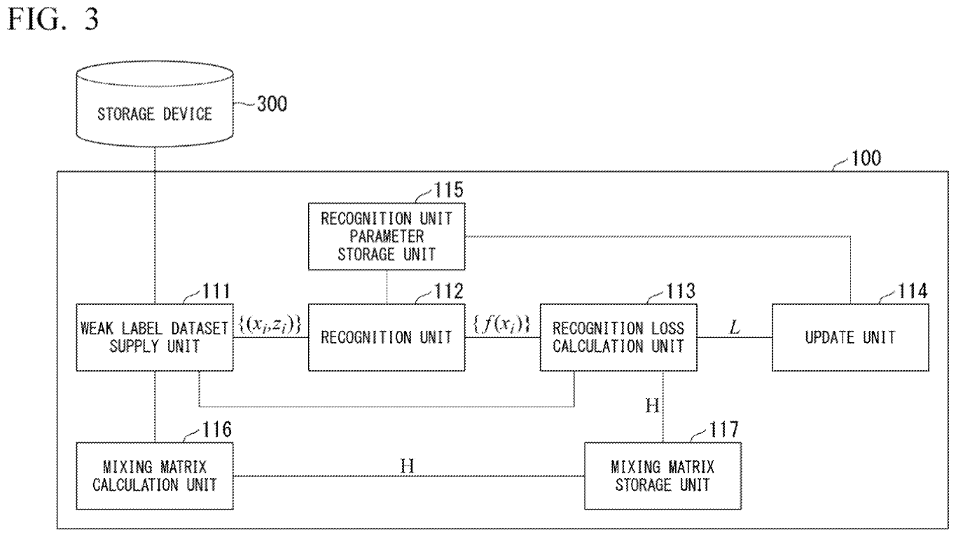

The recording medium 105 is a non-volatile and non-transitory recording medium such as a disc-like recording medium or a semiconductor memory and is configured to be attachable and detachable to and from the learning device 100. The recording medium 105 records various programs which are executed by the processor 103. Here, “various programs” are programs including computer programs for causing a computer to realize each function of the learning device 100 to be described with reference to FIGS. 3 to 6. When the learning device 100 executes various processes, programs recorded in the recording medium 105 are loaded into the memory 104 and executed by the processor 103.

The database 106 stores a weak label dataset used for learning. In addition to the above, the learning device 100 may be provided with an input instrument such as a keyboard or a mouse for a user to perform instructions or inputs, and a display unit.

(Functional Configuration of Learning Device)

FIG. 3 is a block diagram illustrating a functional configuration of the learning device according to the example embodiment. The learning device 100 includes a weak label dataset supply unit 111, a recognition unit 112, a recognition loss calculation unit 113, an update unit 114, a recognition unit parameter storage unit 115, a mixing matrix calculation unit 116, and a mixing matrix storage unit 117. In addition, the learning device 100 performs a learning process using a weak label dataset that is a dataset for learning stored in a storage device 300. The storage device 300 that stores the dataset for learning may be included in the learning device 100, or may be another device configuration different from the learning device 100 as shown in FIG. 3.

The weak label dataset supply unit 111 supplies input data of the weak label dataset stored in the storage device 300 to the recognition unit 112 and the recognition loss calculation unit 113. Specifically, the weak label dataset supply unit 111 supplies a pair {xᵢ, zᵢ} of the data xᵢ and the weak label zᵢ (hereinafter referred to as “a pair of input data”) to the recognition unit 112 and the recognition loss calculation unit 113. The recognition unit 112 has a recognition model which is internally constituted by a neural network or the like. The recognition unit 112 performs a recognition process using a recognition model for an input xᵢ that is image data and outputs a recognition result f(xᵢ) to the recognition loss calculation unit 113. The recognition result f(xᵢ) is a vector having the same dimension as the number of elements in the correct answer candidate set Y, and each component thereof is a real value representing the relative plausibility of each class. Generally, each component of the recognition result f(xᵢ) may take any real value but may be normalized so that the total sum of the components is 1, as necessary, as a non-negative value. As the normalization, a method using a softmax function is general, but there is no limitation to this method.

On the other hand, the mixing matrix calculation unit 116 calculates the mixing matrix H on the basis of the attribute value of the weak label dataset and supplies it to the mixing matrix storage unit 117. The mixing matrix will be described in detail later. The mixing matrix storage unit 117 stores the supplied mixing matrix H and supplies it to the recognition loss calculation unit 113.

The recognition loss calculation unit 113 calculates a recognition loss L using the pair {xᵢ, zᵢ} of input data supplied from the weak label dataset supply unit 111, the recognition result f(xᵢ) supplied from the recognition unit 112, and the mixing matrix H and supplies it to the update unit 114. The recognition loss L will be described in detail later. The update unit 114 updates parameters constituting the recognition model of the recognition unit 112 on the basis of the recognition loss L and supplies the updated parameters to the recognition unit parameter storage unit 115. The recognition unit parameter storage unit 115 stores the updated parameters supplied from the update unit 114. The recognition unit 112 reads out the parameters stored in the recognition unit parameter storage unit 115 at a timing of updating the parameters and sets them as parameters during the recognition process. In this way, learning of the recognition unit 112 is performed using the weak label dataset as data for learning.

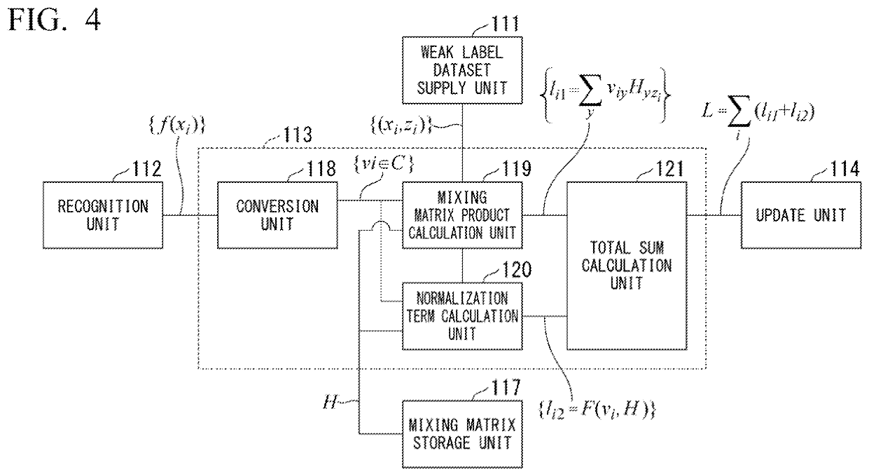

FIG. 4 is a block diagram illustrating a detailed functional configuration of the recognition loss calculation unit 113. The detailed processing content of each component of the recognition loss calculation unit 113 will be described in detail later, and only the outline thereof will be shown here. The recognition loss calculation unit 113 includes a conversion unit 118, a mixing matrix product calculation unit 119, a normalization term calculation unit 120, and a total sum calculation unit 121. The conversion unit 118 converts the recognition result f(xᵢ) supplied from the recognition unit 112 into a conjugate vector vᵢ. The mixing matrix product calculation unit 119 calculates a product lᵢ₁ from the conjugate vector vᵢ supplied from the conversion unit 118, the mixing matrix H supplied from the mixing matrix storage unit 117, and the input data {xᵢ, zᵢ} supplied from the weak label dataset supply unit 111. The normalization term calculation unit 120 calculates a normalization term lᵢ₂ from the conjugate vector vᵢ supplied from the conversion unit 118 and the mixing matrix H supplied from the mixing matrix storage unit 117. The total sum calculation unit 121 calculates the total sum of the product lᵢ₁ supplied from the mixing matrix product calculation unit 119 and the normalization term lᵢ₂ supplied from the normalization term calculation unit 120 and supplies the calculated total sum to the update unit 114 as a loss function L.

(Mixing Matrix)

First, the mixing matrix H will be described in detail. The mixing matrix H is a rectangular matrix having the same number of rows as the number of elements in the correct answer candidate set Y and having the same number of columns as the number of elements in the weak label set Z. Among matrices having such a shape, a matrix satisfying Expression (4) is adopted as the mixing matrix H. That is, assuming a matrix M is a matrix having the same number of rows as the number of elements in the weak label set Z and having the same number of columns as the number of elements in the correct answer candidate set Y, and its component of the z-th row and y-th column is as follows,

[Math. 6]

M_{zy}=p(z|y) (6)

the mixing matrix H is its left inverse matrix M⁺

[Math. 7]

H=M⁺ (7)

The mixing matrix calculation unit 116 calculates the mixing matrix H by calculating the left inverse matrix M⁺ of the matrix M given by Expression (6) in accordance with Expression (7). In a case where the number of elements in the correct answer candidate set Y and the number of elements in the weak label set Z are different from each other, there are innumerable left inverse matrices of the matrix M, but any of them may be used.

(Recognition Loss)

Next, the recognition loss calculated by the recognition loss calculation unit 113 will be described in detail.

In a case where learning is performed using a weak label dataset, a loss function is defined using the mixing matrix H. However, in the related art, since the mixing matrix is used as the weight of the weighted sum of positive semi-definite value functions, and the elements of the mixing matrix have negative values, the resulting loss function can take a negative value. When the loss function can take a negative value, the execution of learning causes an endless increase in negatively weighted terms with, which leads to obstruction of learning. Consequently, in the present example embodiment, the aforementioned problem is solved by adding a normalization term to the loss of the mixing matrix H.

In the related art, the loss function L is calculated by the following two steps for the set {(xᵢ, zᵢ)} of pairs (xᵢ, zᵢ) of the input data xᵢ and the weak label zᵢ attached to the input data. In the first step, a loss l(f(xᵢ), y) between the recognition result f(xᵢ) and each element y in the correct answer candidate set Y is calculated using a function l having a positive semi-definite value. In the second step, the loss calculated in the first step is weighted by the mixing matrix H and added over the learning data. As a result, the loss function L is defined as follows.

$$\begin{matrix}[ Math . 8 ] & \\ L = {\sum }_{i} {\sum }_{y} {H}_{y {z}_{i}} l ( f ( {x}_{i} ) , y ) & ( 8 )\end{matrix}$$

On the other hand, in the present example embodiment, the conversion unit 118 first converts the recognition result f(xᵢ) into the conjugate vector vᵢ. The conjugate vector is an element of a convex subset C of the orthogonal complementary space for a vector of which all the elements are 1 in the Euclidean space having the same dimension as the number of elements in the correct answer candidate set Y. The selection of a convex set C is arbitrary and may be for the entire orthogonal complementary space for a vector of which all the elements are 1. The role of the conversion unit 118 is to associate the recognition result that can take any vector value with points on the convex set C, and the specific processing content of the conversion unit 118 is arbitrary insofar as the points on the convex set C can be expressed without excess or deficiency.

Next, the mixing matrix product calculation unit 119 calculates the product lᵢ₁ based on the following expression from the conjugate vector vᵢ supplied from the conversion unit 118, the mixing matrix H supplied from the mixing matrix storage unit 117, and the weak label zᵢ supplied from the weak label dataset supply unit 111.

$$\begin{matrix}[ Math . 9 ] & \\ {l}_{i 1} = - {\sum }_{y} {H}_{y {z}_{i}} {v}_{iy} & \end{matrix}$$

Next, the normalization term calculation unit 120 calculates the normalization term lᵢ₂ based on the following expression from the conjugate vector vᵢ supplied from the conversion unit 118 and the mixing matrix H supplied from the mixing matrix storage unit 117.

[Math. 10]

lᵢ₂=−F(vᵢ,H)

Here, the function F is a convex function defined on the convex set C which has a certain real number α and satisfies the following two inequalities with respect to any conjugate vector v that is an element of C.

$$\begin{matrix}[ Math . 11 ] & \\ F ( v , H ) \geq {max}_{y} {v}_{y} + a F ( v , H ) \geq {max}_{z} {\sum }_{y} {H}_{y z} {v}_{y} + α & \end{matrix}$$

Specific examples of the convex function F satisfying this condition include the following examples, but the selection of the convex function F is not limited to the following specific examples and is arbitrary insofar as this inequality is satisfied.

$$\begin{matrix}[ Math . 12 ] & \\ F ( v , H ) = \frac{1}{2} {v}^{2} F ( v , H ) = log [ {\sum }_{y} exp {v}_{y} + {\sum }_{z} exp ( {\sum }_{y} {H}_{yz} {v}_{y} ) ] F ( v , H ) = max \{ {max}_{y} {v}_{y} {, max}_{z} {\sum }_{y} {H}_{y z} {v}_{y} \} & \end{matrix}$$

The total sum calculation unit 121 adds the total sum of the product lᵢ₁ and the normalization term lᵢ₂ over the learning data. As a result, the loss function L is calculated as follows.

$$\begin{matrix}[ Math . 13 ] & \\ L = {\sum }_{i} ( {l}_{i 1} + {l}_{i 2} ) = {\sum }_{i} ( - {\sum }_{y} {H}_{{yz}_{i}} {v}_{iy} + F ( {v}_{i} , H ) ) & \end{matrix}$$

The recognition loss calculated by the recognition loss calculation unit 113 in this way maintains positive definiteness insofar as the function F satisfies the above condition. As a result, it is also possible to execute learning based on the loss function of a positive semi-definite value from the weak label dataset.

(Learning Process Performed by Learning Device)

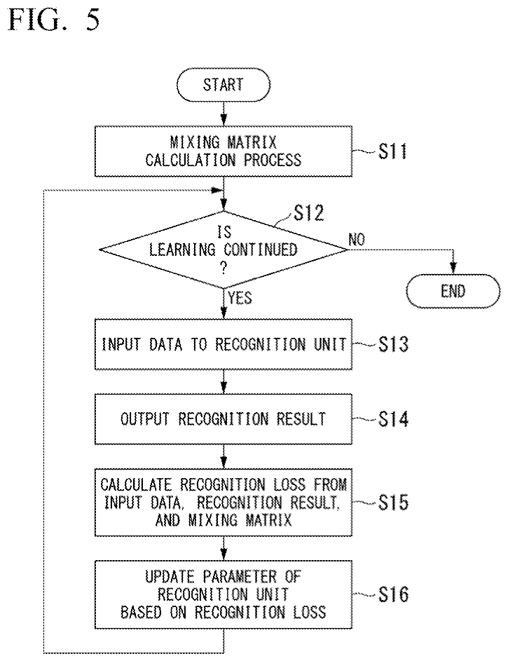

FIG. 5 is a flowchart of a learning process performed by the learning device 100. First, the mixing matrix calculation unit 116 calculates the mixing matrix H using the weak label probability distribution provided in the weak label dataset through the above-described method (step S11). The mixing matrix calculation unit 116 outputs the calculated mixing matrix H to the mixing matrix storage unit 117, and the mixing matrix storage unit 117 stores the input mixing matrix H.

Next, the learning device 100 determines whether to continue learning (step S12). This determination is performed on the basis of whether an end condition determined in advance is satisfied. Examples of the end condition include whether all pieces of prepared data for learning has been used, whether the number of parameter updates has reached a predetermined number of times, and the like.

In a case where it is determined to continue learning (step S12: Yes), the weak label dataset supply unit 111 inputs a pair of input data to the recognition unit 112 and the recognition loss calculation unit 113 (step S13). The recognition unit 112 performs the recognition process on the basis of the input data and outputs the recognition result to the recognition loss calculation unit 113 (step S14).

Next, the recognition loss calculation unit 113 calculates the recognition loss L through the above-described method using the input data, the recognition result, and the mixing matrix (step S15). The update unit 114 then updates the parameters of the recognition unit 112 so that the calculated recognition loss L becomes small (step S16). That is, the recognition unit parameter storage unit 115 stores the updated parameters, and the recognition unit 112 makes a setting for the learning process for a model that learns the updated parameters stored in the recognition unit parameter storage unit 115. In this way, the learning device 100 repeats steps S12 to S16, and in a case where it is determined that learning is not continued in step S12 (step S12: No), the process ends.

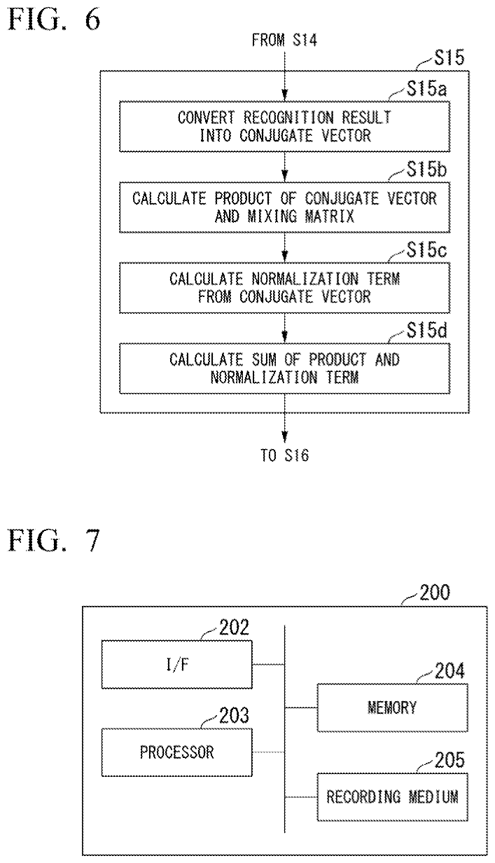

FIG. 6 is a flowchart illustrating an operation of the recognition loss calculation unit 113 and is a flowchart illustrating the process in step S15 of FIG. 5 in more detail.

The conversion unit 118 converts the recognition result f(xᵢ) supplied from the recognition unit 112 into the conjugate vector vᵢ (step S15a).

The mixing matrix product calculation unit 119 calculates the product lᵢ₁ from the conjugate vector vᵢ supplied from the conversion unit 118, the mixing matrix H supplied from the mixing matrix storage unit 117, and the input data {xᵢ, zᵢ} supplied from the weak label dataset supply unit 111 (step S15b).

The normalization term calculation unit 120 calculates the normalization term lᵢ₂ from the conjugate vector vᵢ supplied from the conversion unit 118 and the mixing matrix H supplied from the mixing matrix storage unit 117 (step S15c).

The total sum calculation unit 121 calculates the total sum of the product lᵢ₁ supplied from the mixing matrix product calculation unit 119 and the normalization term lᵢ₂ supplied from the normalization term calculation unit 120 and supplies the calculated total sum to the update unit 114 as the loss function L (recognition loss L) (step S15d).

[Example Embodiment of Inference Device]

Next, an embodiment of an inference device using the recognition unit 112 trained by the learning device 100 will be described.

(Hardware Configuration)

FIG. 7 is a block diagram illustrating a hardware configuration of an inference device according to an example embodiment. As shown in the drawing, an inference device 200 includes an interface 202, a processor 203, a memory 204, and a recording medium 205.

The interface 202 inputs and outputs data to and from an external device. Specifically, input data such as an image recognized by the inference device 200 is input through the interface 202.

The processor 203 is a central processing unit (CPU) or a computer such as a CPU and a graphics processing unit (GPU) and controls the entirety of the inference device 200 by executing a program prepared in advance. Specifically, the processor 203 executes an inference process to be described later.

The memory 204 is constituted by a read only memory (ROM), a random-access memory (RAM), or the like. The memory 204 stores the parameters of an inference unit trained by the learning device 100. In addition, the memory 204 is also used as a working memory during the execution of various processes performed by the processor 203.

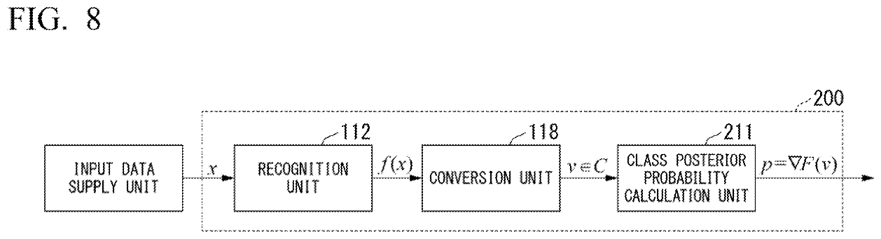

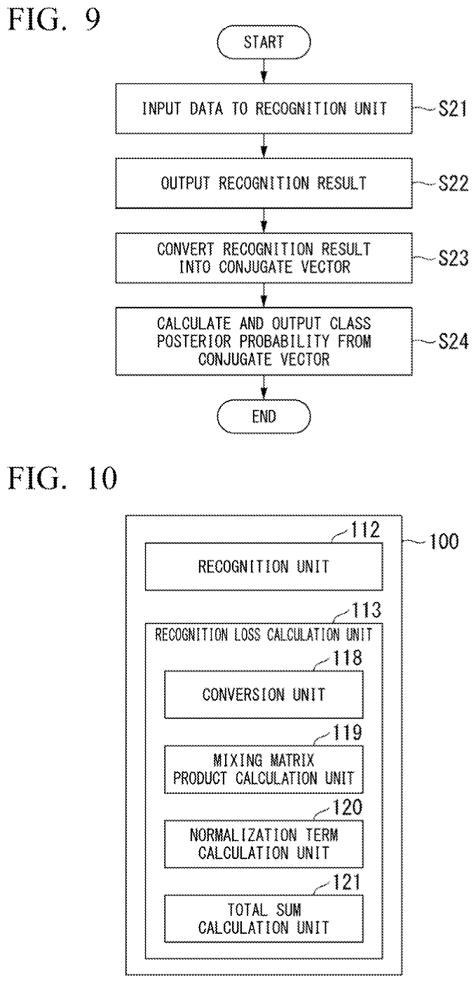

The recording medium 205 is a non-volatile and non-transitory recording medium such as a disc-like recording medium or a semiconductor memory and is configured to be attachable and detachable to and from the inference device 200. The recording medium 205 records various programs which are executed by the processor 203 or the parameters of the inference unit trained by the learning device 100. Here, “various programs” are programs including computer programs for causing a computer to realize each function of the inference device 200 to be described with reference to FIGS. 8 and 9. When the inference device 200 executes various processes, programs or parameters recorded in the recording medium 205 are loaded into the memory 204 and executed by the processor 203.

In addition to the above, the inference device 200 may be provided with an input instrument such as a keyboard or a mouse for a user to perform instructions or inputs, and a display unit.

(Functional Configuration of Inference Device)

FIG. 8 is a block diagram illustrating a functional configuration of the inference device 200. The inference device 200 includes the recognition unit 112 trained by the learning device 100, the conversion unit 118, and a class posterior probability calculation unit 211. The functions of the recognition unit 112 and the conversion unit 118 are the same as those of the recognition unit 112 and the conversion unit 118 in the learning device 100, and thus the detailed description thereof will be omitted.

The class posterior probability calculation unit 211 converts the conjugate vector v calculated by the conversion unit 118 into a class posterior probability that is a probability of the input data belonging to each class. A vector p having a posterior probability p_{y} belonging to the class y as a component and having the same dimension as the number of elements in the correct answer candidate set Y is calculated on the basis of the following expression using the conjugate vector v corresponding to the input data x and the convex function F calculated by the normalization term calculation unit 120 included in the learning device 100.

[Math. 14]

p=∇F(v)

Here, in a case where the convex function F is not differentiable, ∇ represents a subgradient. When ∇ is a subgradient, the output of the class posterior probability calculation unit is the entire subgradient or the representative element of the subgradient.

(Inference Process Performed by Inference Device)

FIG. 9 is a flowchart of an inference process performed by the inference device 200. First, the recognition unit 112 performs the recognition process on the basis of the input data and supplies the recognition result to the conversion unit 118 (step S21). Next, the conversion unit 118 converts the recognition result into a conjugate vector and supplies it to the class posterior probability calculation unit 211 (step S22). The class posterior probability calculation unit 211 then calculates the class posterior probability from the conjugate vector, outputs the result, and the process ends.

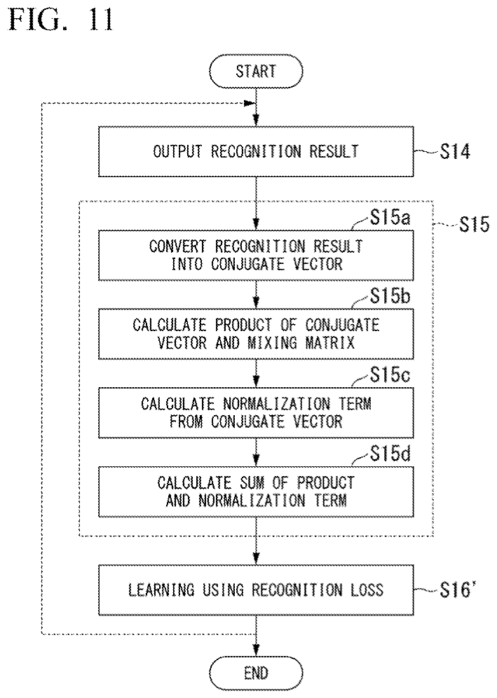

FIG. 10 is a diagram illustrating a minimum configuration diagram of the learning device 100. FIG. 11 is a diagram illustrating a process flow diagram of the learning device 100 in the minimum configuration shown in FIG. 10.

The learning device 100 includes the recognition unit 112 (recognition unit) and the recognition loss calculation unit 113 (recognition loss calculation unit). The recognition unit 112 outputs the recognition result with respect to the recognition object data in the dataset for learning that is a set of pairs of the recognition object data and the weak label attached to the recognition object data (step S14).

The recognition loss calculation unit 113 calculates the recognition loss using the recognition result, the mixing matrix calculated on the basis of the dataset for learning, and the weak label (step S15).

The dataset for learning has a weak label probability distribution, and the weak label probability distribution is a probability distribution according to the weak label conditioned by a true correct answer class to which the recognition object data belongs and is reconfigurable.

The recognition loss calculation unit 113 includes the conversion unit 118 (conversion unit), the mixing matrix product calculation unit 119 (mixing matrix product calculation unit), the normalization term calculation unit 120 (normalization term calculation unit), and the total sum calculation unit 121 (total sum calculation unit).

The conversion unit 118 converts the recognition result into a conjugate vector (step S15a).

The mixing matrix product calculation unit 119 calculates a product of the conjugate vector and the mixing matrix (step S15b).

The normalization term calculation unit 120 calculates a normalization term from the conjugate vector (step S15c).

The total sum calculation unit 121 calculates a sum of the product and the normalization term and outputs the calculated sum as the recognition loss (step S15d).

The recognition unit 112 performs learning using the recognition loss (step S16’).

The learning device 100 may perform learning by repeating up to an end condition determined in advance.

Hereinbefore, although the present disclosure has been described with reference to the example embodiments and examples, the present disclosure is not limited to the above example embodiments and examples. Various modifications and changes that can be understood by those skilled in the art can be made to the configuration and details of the present disclosure within the scope of the present disclosure.

### REFERENCE SYMBOLS

100 Learning device
111 Weak label dataset supply unit
112 Recognition unit
113 Recognition loss calculation unit
114 Update unit
115 Recognition unit parameter storage unit
116 Mixing matrix calculation unit
117 Mixing matrix storage unit
118 Conversion unit
119 Mixing matrix product calculation unit
120 Normalization term calculation unit
121 Total sum calculation unit
200 Inference device
211 Class posterior probability calculation unit

What is claimed is:

1. A learning device comprising:
a memory configured to store instructions; and
a processor configured to execute the instructions to:
output a recognition result with respect to recognition object data in a dataset for learning that is a set of pairs of the recognition object data and a weak label attached to the recognition object data; and
calculate a recognition loss using the recognition result, a mixing matrix calculated based on the dataset for learning, and the weak label,
wherein the dataset for learning has a weak label probability distribution,
wherein the weak label probability distribution is a probability distribution according to the weak label conditioned by a true correct answer class to which the recognition object data belongs and is reconfigurable,
wherein calculating the recognition loss includes
converting the recognition result into a conjugate vector,
calculating a product of the conjugate vector and the mixing matrix,
calculating a normalization term from the conjugate vector, and
calculating a sum of the product and the normalization term and outputting the calculated sum as the recognition loss, and
wherein outputting the recognition result further includes performing learning using the recognition loss.

2. The learning device according to claim 1, wherein the processor is configured to execute the instructions to calculate the mixing matrix based on the dataset for learning.

3. The learning device according to claim 2,
wherein the processor is configured to execute the instructions to update parameters based on the recognition loss,
wherein outputting the recognition result further includes setting the parameters in a learning model.

4. The learning device according to claim 1, wherein the processor is configured to execute the instructions to supply the dataset for learning.

5. The learning device according to claim 1, wherein the dataset for learning is an expert dataset or a PU dataset.

6. A learning method comprising:
outputting a recognition result with respect to recognition object data in a dataset for learning that is a set of pairs of the recognition object data and a weak label attached to the recognition object data; and
calculating a recognition loss using the recognition result, a mixing matrix calculated based on the dataset for learning, and the weak label,
wherein the dataset for learning has a weak label probability distribution,
wherein the weak label probability distribution is a probability distribution according to the weak label conditioned by a true correct answer class to which the recognition object data belongs and is reconfigurable,
wherein calculating the recognition loss includes
converting the recognition result into a conjugate vector,
calculating a product of the conjugate vector and the mixing matrix,
calculating a normalization term from the conjugate vector, and
calculating a sum of the product and the normalization term and outputting the calculated sum as the recognition loss, and
wherein outputting the recognition result further includes performing learning using the recognition loss.

7. A non-transitory computer-readable recording medium for a learning device in which a program for causing a computer to execute a learning method is recorded, the learning method including:
outputting a recognition result with respect to recognition object data in a dataset for learning that is a set of pairs of the recognition object data and a weak label attached to the recognition object data; and
calculating a recognition loss using the recognition result, a mixing matrix calculated based on the dataset for learning, and the weak label,
wherein the dataset for learning has a weak label probability distribution,
wherein the weak label probability distribution is a probability distribution according to the weak label conditioned by a true correct answer class to which the recognition object data belongs, and is reconfigurable,
wherein calculating the recognition loss includes
converting the recognition result into a conjugate vector,
calculating a product of the conjugate vector and the mixing matrix,
calculating a normalization term from the conjugate vector, and
calculating a sum of the product and the normalization term and outputting the calculated sum as the recognition loss, and
wherein outputting the recognition result further includes performing learning using the recognition loss.

8.-10. (canceled)
